(19) United States
(12) Patent Application Publication
(10) Pub. No.: US 2006/0046533 A1
(43) Pub. Date: Mar. 2, 2006

(54) Substrate for connector

(75) Inventors: Taiji Okamoto, Miyagi-ken (JP); Shin Yoshida, Miyagi-ken (JP)

Correspondence Address: BEYER WEAVER & THOMAS LLP, P.O. BOX 70250, OAKLAND, CA, 94612-0250, US

(73) Assignee: ALPS ELECTRIC CO., LTD.

(21) Appl. No.: 11/209,596

(22) Filed: Aug. 22, 2005

(30) Foreign Application Priority Data
Sep. 2, 2004 (JP) 2004-255749

(51) Int. Cl. H01R 12/00

(52) U.S. Cl. 439/74

(57) ABSTRACT

A ground pattern that extends from a conductive portion of a through hole serving as a ground line is disposed in the vicinities of outer circumferences of through holes serving as signal lines. The thickness of a substrate for a connector in a Z direction is small and the lengths of the signal lines are short, such that favorable high-frequency characteristics can be obtained. Further, since only one of the through holes is sufficient to be used as the ground line, the remaining through holes can be used as signal lines. Therefore, the number of signal lines can be increased.

### BACKGROUND OF THE INVENTION

1. Field of the Invention

The present invention relates to a flat connector that has a plurality of spiral contactors, and more particularly, to a flat connector that can enhance a ground line so as to obtain favorable high-frequency characteristics.

2. Description of the Related Art

Japanese Unexamined Patent Application Publication No. 2003-168523 (hereinafter, referred to as Patent Document 1) is an example of the related art. In Patent Document 1, a connector for a flexible printed wiring board which has improved high-frequency-band transmission (high-frequency characteristics) is disclosed.

The connector for a flexible printed wiring board disclosed in Patent Document 1 has features that (1) a shield plate 2 is provided so as to cover the substantially entire surface of a connector 1, and (2) the connector 1 has signal terminals 4 correspondingly brought into contact with signal lines 7 on a flexible printed wiring board 5, and ground terminals 3 brought into contact with the shield plate 2 and auxiliary conductive lines 6 of the flexible printed wiring board 5 between adjacent signal lines 7.

In the connector disclosed in Patent Document 1, in order to obtain favorable high-frequency characteristics, one signal terminal 4 is interposed between ground terminals 3 provided at both sides of that signal terminal 4. In this case, the number of signal terminals in the connector as a whole is difficult to increase.

In particular, in the connector, connecting terminals (contact pins), which has the ground terminals 3 or the signal terminals 4 connected the flexible printed wiring board, are arranged in a line in a traverse direction with respect to a housing 10. Therefore, in order to provide a plurality of connecting terminals, the connector itself needs to be expanded. Further, there is a limitation to increase the number of connecting terminals while maintaining a constant size.

In addition, in the connector disclosed in Patent Document 1, a front end (an inserted end) of the flexible printed wiring board is pressed by a housing receiving portion. However, the housing receiving portion of the housing is formed so as to be disposed above the inserted end. Accordingly, the thickness of the connector is increased by the thickness of the housing receiving portion.

Specifically, in the above-described connector, the number of connecting terminals is difficult to increase or the entire connector is difficult to be reduced in size, while favorable high-frequency characteristics are maintained.

### SUMMARY OF THE INVENTION

The invention has been made in consideration of the above-described problems, and it is an object of the invention to provide a substrate for a connector which has favorable high-frequency characteristics, on which a plurality of connecting terminals can be mounted, and which can be reduced in size as a whole.

According to an aspect of the invention, a substrate for a connector includes a first surface on which a plurality of contactors are provided, a second surface on which a plurality of connecting bumps to be electrically connected to an external circuit board are provided, and a plurality of through holes that are formed to pass through in a vertical direction between the first surface and the second surface and connect the contactors and the connecting bumps, correspondingly. The through holes form signal lines that transmit signals between the contactors and the connecting bumps and a ground line that serves to ground. A ground pattern is provided on the substrate so as to extend from the ground line in a direction perpendicular to the vertical direction while bypassing the signal lines.

According to this configuration, the ground pattern corresponding to the plurality of signal lines can be collectively provided with a simple configuration and the substrate for a connector having excellent high-frequency characteristics can be provided. Further, the number of through holes to be used as the ground line can be reduced, and thus most of the through holes can be used as the signal lines.

In the substrate for a connector according to the first aspect of the invention, the ground pattern may be provided on the first surface. When the substrate is a multi-layered substrate, the ground pattern may be provided on an intermediate layer between the first surface and the second surface.

In this configuration, it is preferable that a plurality of via holes, each having a conductive layer, be provided between the ground pattern and at least one of the first surface and the second surface.

According to this configuration, electromagnetic shield can be realized by surrounding the signal lines with the grounded conductive layers. Therefore, a substrate for a connector, which is not affected by high-frequency noise, can be provided.

Further, a portion of the ground pattern can be exposed to the outside of the substrate as a ground terminal.

According to this configuration, the ground line and the ground pattern can be simply and reliably grounded.

Further, it is preferable that the contactors and the connecting bumps be arranged in planar matrix shapes. Further, it is preferable that the contactors be spiral contactors.

### BRIEF DESCRIPTION OF THE DRAWINGS

FIG. 1 is an exploded perspective view showing an embodiment of a connector on which a substrate for a connector according to the invention is mounted;

FIG. 2 is a cross-sectional view showing a substrate for a connector according to a first embodiment of the invention taken along the line II-II of FIG. 1;

FIG. 3 is a perspective view showing the substrate for a connector in part and spiral contactors;

FIG. 4 is a partial perspective view of a flexible sheet as viewed from the Z2 side;

FIG. 5 is a cross-sectional view of the connector taken along the line II-II shown in FIG. 1 before the flexible printed wiring board is mounded;

FIG. 6 is a cross-sectional view of the connector taken along the line II-II shown in FIG. 1 after the flexible printed wiring board is mounted;

FIG. 7 is a cross-sectional view of a substrate for a connector according to a second embodiment of the invention, which corresponds to FIG. 2;

FIG. 8 is a cross-sectional view of a substrate for a connector according to a third embodiment of the invention, which corresponds to FIG. 2; and

FIG. 9 is a perspective view showing the substrate for a connector in FIG. 8 in a partial cross-sectional view.

### DESCRIPTION OF THE PREFERRED EMBODIMENT

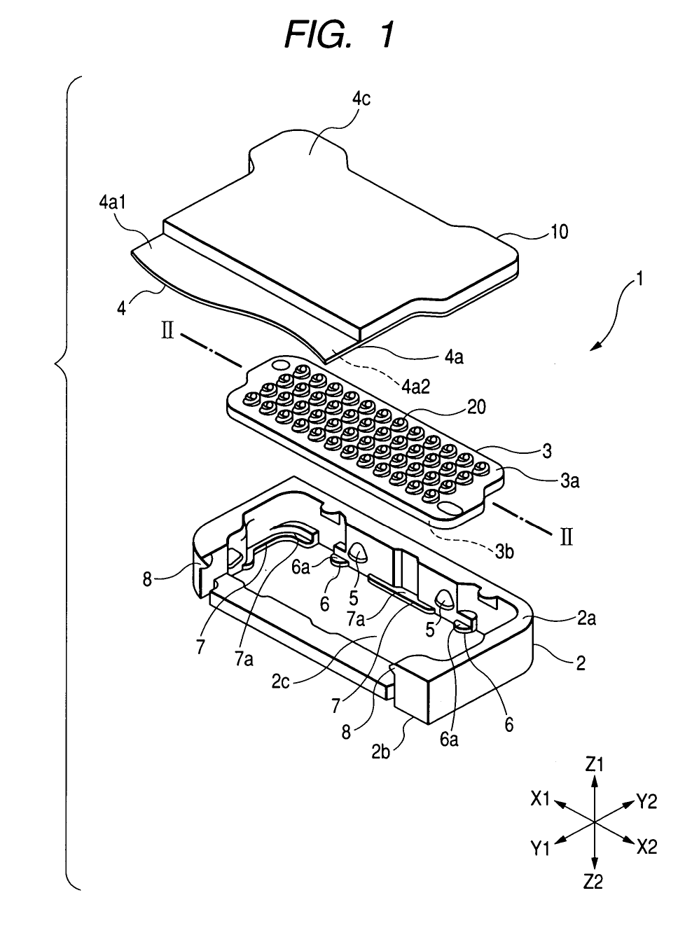

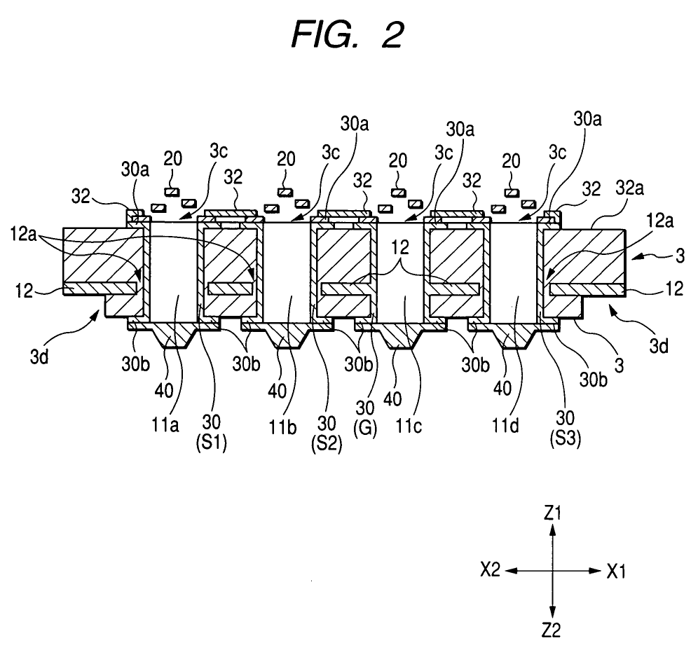

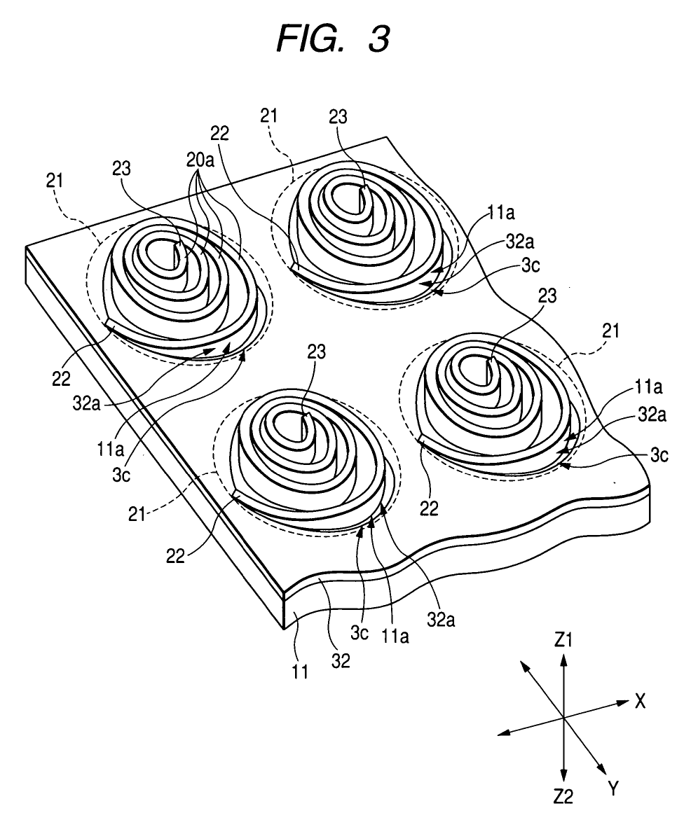

FIG. 1 is an exploded perspective view showing an embodiment of a connector on which a substrate for a connector according to the invention is mounted. FIG. 2 is a cross-sectional view showing a substrate for a connector according to a first embodiment of the invention taken along the line II-II of FIG. 1. FIG. 3 is a perspective view showing the substrate for a connector in part and spiral contactors.

A substrate for a connector according to the invention is used, for example, for a connector 1 shown in FIG. 1. The connector 1 is a connector having a face-to-face structure in which, when an external-connecting-portion forming surface of a flexible printed wiring board faces a contactor forming surface of a substrate to be described below, external connecting portions formed on the external-connecting-portion forming surface are electrically connected to contactors formed on the contactor forming surface.

The connector 1 has a housing 2, a substrate 3 for a connector, and a flexible printed wiring board 4.

As shown in FIG. 1, a fitting portion 2c is formed to pass through the housing 2 in a Z direction of the drawing. The substrate 3 for a connector has a top surface 3a serving as a first surface and a bottom surface 3b serving as a second surface.

As shown in FIGS. 1 and 2, a plurality of spiral contactors 20 serving as contactors of the invention are formed on the top surface 3a of the substrate 3 of a connector. As shown in FIG. 3, the plurality of spiral contactors 20 are formed on the top surface 3a of the substrate 3 at predetermined gaps in X and Y directions of the drawing. The spiral contactors 20 are spirally formed and are arranged on the top surface 3a in a matrix shape (in a lattice shape or in a grid shape) at the predetermined gaps in the X and Y directions of the drawing.

As shown in FIG. 2, in the substrate 3 for a connector, through holes 11 (individually represented by 11a, 11b, 11c, and 11d) are formed to pass through in a vertical direction (in the Z direction) between the top surface (the first surface) 3a and the bottom surface (the second surface) 3b. On the inner surfaces of the through holes 11, conductive portions 30 made of conductive materials are formed. Further, as shown in FIG. 2, upper and lower edges of the conductive portions 30 extend on the top surface 3a and the bottom surface 3b from edges of the through holes 11 in the horizontal directions in ring shapes so as to form upper ends 30a and lower ends 30b. Further, the substrate 3 for a connector is an insulating substrate, which is obtained by mixing glass fibers in epoxy resin, for example.

Each spiral contactor 20 has a base 21, and a winding start 22 of the spiral contactor 20 is provided at the base 21 side. A winding end 23 thereof is formed at the front end extending from the winding start 22 in a spiral shape.

Each spiral contactor 20 shown in FIG. 3 is formed into a three-dimensional conical shape that projects upward (toward the Z1 direction in FIG. 3) so as to project highest near the winding end 23.

The spiral contactor 20 can be made of a material, such as copper (Cu), nickel (Ni), and gold (Au). The spiral contactor 20 may be made of a single layer of one of these materials, or may be made of a laminate of a plurality of layers, each being made of one of the materials, such as a laminate of Cu and Ni or a laminate of Ni and Au. Further, the spiral contactor 20 can be manufactured by plating with the materials.

The bases 21 of the spiral contactors 20 are connected to each other by a bonding member 32. The bonding member 32 is provided with a hole 32a larger than the spiral contactors 20 by a single rotation. The hole 32a and the spiral contactor 20 are aligned with each other, and the bonding member 32 is attached to the bases 21 of the spiral contactors 20. The bonding member 32 is made of polyimide or the like.

As shown in FIG. 2, the upper end 30a of the conductive portion 30 and the base 21 of the spiral contactor are bonded to each other by a bonding unit, such as a conductive adhesive or the like, such that the through hole 11 and the hole 32a face each other. Therefore, an opening 3c is formed by the through hole 11 and the hole 32a. Further, the winding end 23 is formed to be disposed at the center of the through hole 11.

The lower end 30b of the conductive portion 30 is connected to a corresponding connecting bump 40. Then, the connecting bump 40 faces the spiral contactor 20 with the through hole 11 interposed therebetween. The connecting bumps 40 are arranged on the bottom surface 3b in a matrix shape (in a lattice shape or in a grid shape) at predetermined gaps in the X and Y directions of the drawing.

Each connecting bump 40 can be made of a material, such as Cu, Ni, and Au. The connecting bump 40 may be made a single layer of one of these materials or may be made of a laminate of a plurality of layers, each being made of one of the materials, such as a laminate of Cu and Ni or a laminate of Ni and Au. Further, the connecting bump 40 can be manufactured by directly plating with the materials on the bottom surface 3b of the substrate 3 for a connector. However, the connecting bumps 40 may be formed in advance and then may be adhered to the bottom surface 3b of the substrate 3 for a connector.

In the substrate 3 for a connector, any one selected from the plurality of through holes 11 serves as a ground line. For example, in the substrate 3 for a connector shown as the first embodiment in FIG. 2, the conductive portion 30 of the through hole 11c is made to be the ground line that serves to ground. Further, the conductive portions 30 of other through holes 11 (for example, through holes 11a, 11b, and 11d) serve as signal lines that transmit signals.

Specifically, in the conductive portion 30 of the through hole 11c, a ground pattern 12 planarly extending from the outer circumference of the conductive portion 30 in a horizontal direction (a direction perpendicular to a vertical direction (a Z direction)) in FIG. 2 is made of a conductive material, such as Cu or the like. In the ground pattern 12, a plurality of bypass holes 12a, each having a diameter larger than that of each through hole 11, are formed in a matrix shape. The conductive portions 30 of the through holes 11, excluding the through hole 11c serving as the ground line, that is, the conductive portions 30 of the through holes 11a, 11b, and lid serving as the signal lines, are inserted into the bypass holes 12a, correspondingly, so as to be electrically disconnected from the ground pattern 12. That is, the ground pattern 12 planarly extends in the horizontal direction while bypassing the signal lines through the bypass holes 12a.

Hereinafter, the conductive portions 30 of the through holes 11a, 11b, and 11d are referred to as the signal lines S1, S2, and S3, and the conductive portion 30 of the through hole 11c is referred to as the ground line G.

As shown in FIG. 2, in the lower portion of the substrate 3 for a connector in Y1 and Y2 directions, step portions 3d are formed by cutting portions of the substrate, and then a portion of the ground pattern 12 provided in the substrate 3 for a connector is exposed to the outside via the step portions 3d.

Moreover, if the substrate 3 for a connector is a multi-layered substrate, the ground pattern 12 may be provided on an intermediate layer between the top surface (the first surface) 3a and the bottom surface (the second surface) 3b.

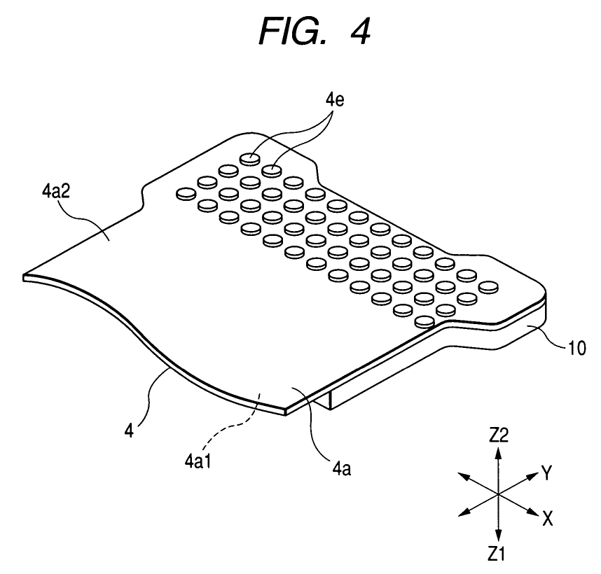

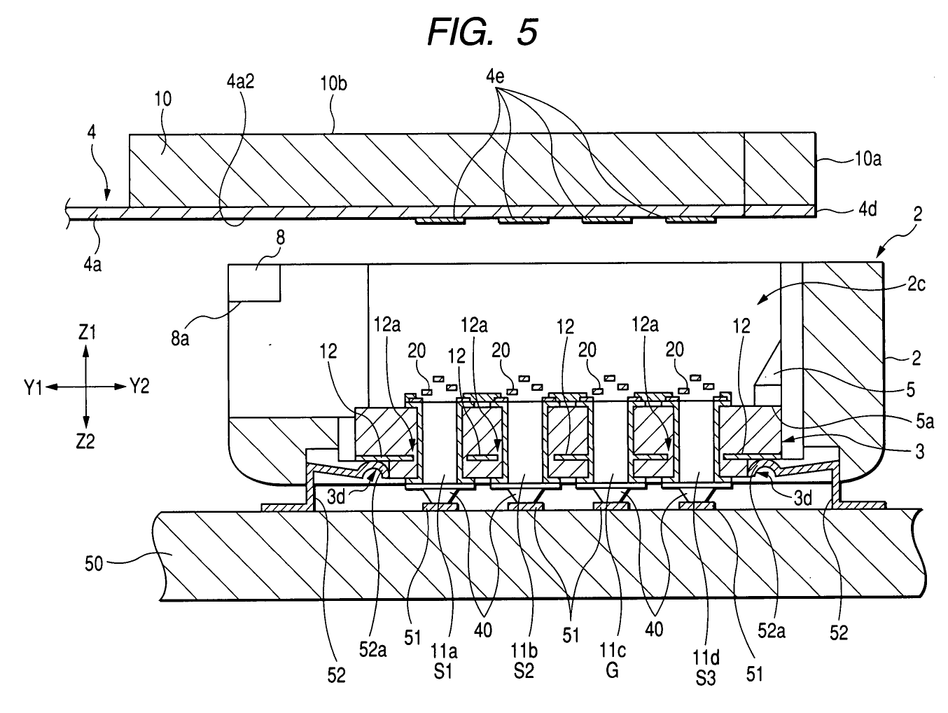

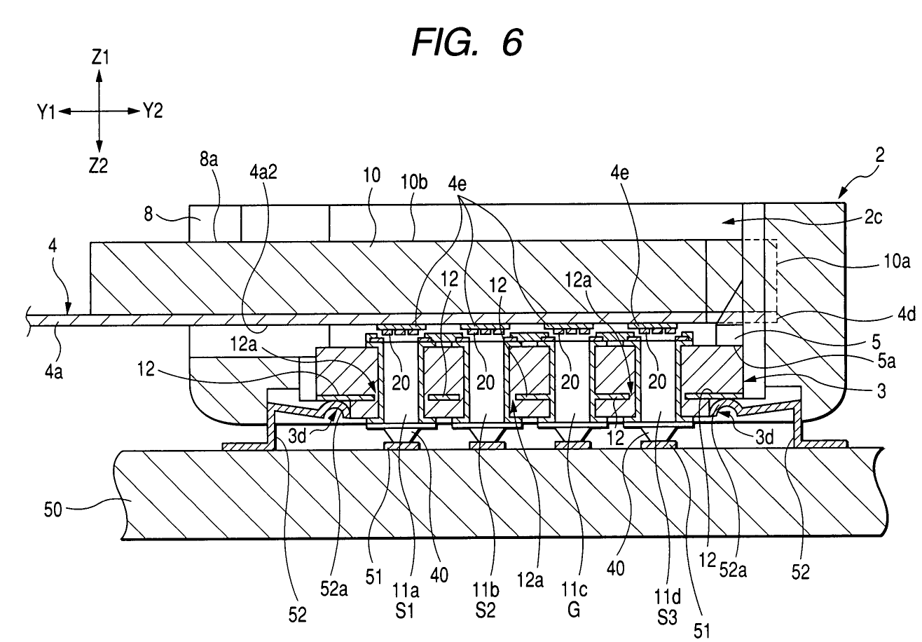

FIG. 4 is a partial perspective view of a flexible sheet as viewed from the Z2 side, and FIGS. 5 and 6 are cross-section views of the connector taken along the line II-II of FIG. 1. In particular, FIG. 5 shows a state before the flexible printed wiring board is mounded and FIG. 6 shows a state after the flexible printed wiring board is mounted.

On the other hand, the flexible printed wiring board 4 includes a flexible sheet 4a having flexibility and insulation. As shown in FIGS. 1 and 4, on the top surface 4a1 of the flexible sheet 4a at the Z1 side in the drawings, a plurality of conductor lines (not shown) constituting a circuit are formed. The plurality of conductor lines are fixed to a fitting member 10 in a front end region of the top surface 4a1 for reinforcement.

As shown in FIG. 4, on the bottom surface (the surface at the Z2 side) 4a2 of the flexible sheet 4a, a plurality of external connecting portions 4e are formed to be electrically connected to the plurality of conductor lines, correspondingly. Each external connecting portion 4e is made of a conductor in a circular shape. In addition, the external connecting portions 4e are arranged on the bottom surface 4a2 of the flexible sheet 4a in a matrix shape (a lattice shape or a grid shape) at predetermined gaps in the X and Y directions of the drawing.

The fitting member 10 is made of, for example, epoxy resin with glass fibers mixed therein and has a thickness in a range of from 200 to 800 μm. For example, the fitting member 10 may be formed to have the thickness of 500 μm. In addition, the thickness of the flexible sheet 4a is, for example, 0.1 to 0.2 μm.

As shown in FIG. 5, the substrate 3 for a connector is held inside the housing 2 while being fitted into the fitting portion 2c. The connecting bumps 40 provided on the bottom surface 3b of the substrate 3 for a connector are exposed on the bottom surface of the housing 2 and are soldered to a plurality of connecting pads 51 formed on a mother board 50 in a matrix shape, correspondingly. In such a manner, the housing 2 is fixed to the mother board 50.

At this time, as shown in FIGS. 5 and 6, if ground connecting members 52 and 52 made of metal leaf springs or the like are provided on the mother board 50 at the positions corresponding to the step portions 3d and 3d of the substrate 3 for a connector, when the housing 2 having the substrate 3 for a connector is fixed to the mother board 50, elastic contact points 52a of the ground connecting members 52 and 52 can be pressed to come into contact with the ground pattern 12 exposed in the step portions 3d and 3d. This enables the ground line G (the conductive portion 30 of the through hole 11c), the spiral contactors 20 provided on the ground line G, and the ground pattern 12 to be grounded via the ground connecting members 52. Therefore, the external connecting portions 4e of the flexible printed wiring board 4 corresponding to the ground line G and the conductor lines connected thereto can be used as ground lines. That is, the ground pattern 12 exposed in the step portions 3d serves as a ground terminal.

In the connector 1, the flexible printed wiring board 4 is disposed on the substrate 3 for a connector in the housing 2. At this time, the fitting member 10 is fitted into the fitting portion 2c of the housing 2 so as to be locked.

As shown in FIG. 6, in a state in which the substrate 3 for a connector and the flexible printed wiring board 4 are locked in the fitting portion 2c of the housing 2, the plurality of spiral contactors 20 formed on the substrate 3 for a connector face and come into contact with the plurality of external connecting portions 4e formed on the bottom surface 4a2 of the flexible printed wiring board 4 to be electrically connected thereto. In this case, since each spiral contactor 20 is formed in a three-dimensionally swelled shape that projects upward, when the spiral contactors 20 come into contact with the external connecting portions 4e, the winding ends 23 are pressed down in the Z2 direction in FIG. 6 to be elastically deformed into a planar shape. The spiral contactors 20 are electrically connected to the external connecting portions 4e while being pressed to come into contact with the external connecting portions.

In the connector 1, the plurality of spiral contactors 20 are planarly arranged in a matrix shape on the top surface 3a of the substrate 3 for a connector. Further, the plurality of external connecting portions 4e are planarly arranged in a matrix shape on the bottom surface 4a2 of the flexible sheet 4a of the flexible printed wiring board 4. Therefore, in the connector 1, the mounting density of the spiral contactors 20 or the external connecting portions 4e facing the spiral contactors 20 to be electrically connected thereto can be made high. This enables the connector 1 to be reduced in size, even when the plurality of spiral contactors 20 and the plurality of external connecting portions 4e are provided therein.

In addition, since the connecting bumps 40 are also arranged on the bottom surface 3b in a matrix shape (a lattice shape or a grid shape), the connecting pads 51 can be densely arranged on the mother board 50, thereby reducing the mounting area.

Further, in the substrate 3 for a connector, the ground pattern 12 extending from the ground line G (the conductive portion 30 of the through hole 11c) in the vicinity of the outer circumference of each of the signal lines S1, S2, and S3 (the conductive portions 30 of the through holes 11a, 11b, and 11d) can be collectively disposed. In addition, the thickness of the substrate in the Z direction can be made small and the length of each of the signal lines S1, S2, and S3 can be made short. Therefore, favorable high-frequency characteristics can be obtained. Further, only one (for example, the through hole 11c) of the plurality of through holes 11 is sufficient to be provided as the ground line G. That is, a pair of terminals disposed at both sides of one signal terminal do not need to be used as ground terminals, unlike the related art. Therefore, the number of substantially usable ones as signal lines from the plurality of through holes 11 can be increased.

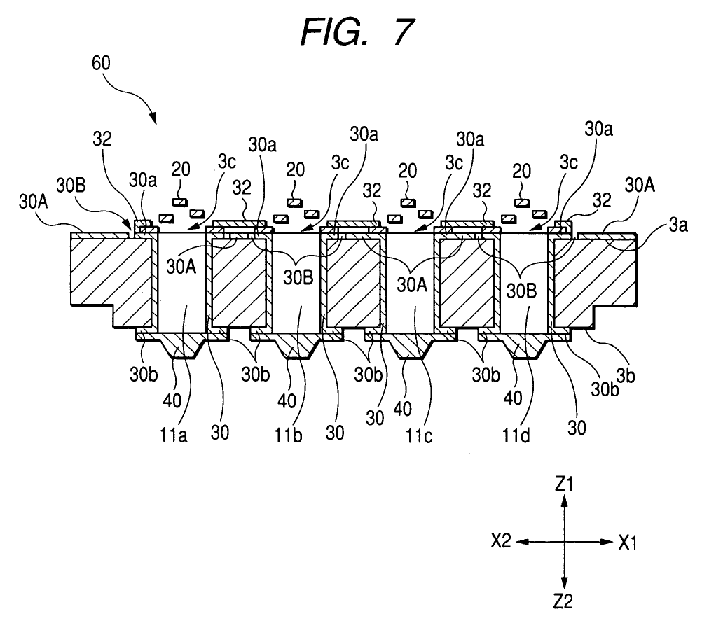

FIG. 7 is a cross-sectional view showing a substrate for a connector according to a second embodiment of the invention, which corresponds to FIG. 2.

The configuration of a substrate 60 for a connector according to the second embodiment of the invention shown in FIG. 7 is almost identical to the configuration of the substrate 3 for a connector described in the first embodiment. Therefore, hereinafter, different parts will be primarily described.

The substrate 3 for a connector according to the first embodiment and the substrate 60 for a connector according to the second embodiment are the same in that a ground pattern extending horizontally from a ground line G in an outer circumferential direction is provided.

However, in the substrate 3 for a connector according to the first embodiment, the ground pattern is formed on the intermediate layer of the substrate 3 for a connector. The second embodiment is different from the first embodiment in that a ground pattern 30A is formed on the top surface 3a.

The ground pattern 30A is formed by expanding the upper end 30a of the through hole 11c serving as a ground line, which extends in a ring shape in the horizontal direction, on the entire top surface (first surface) 3a of the substrate 3 for a connector. However, bypass holes 30B are formed in the outer circumferences of the upper ends 30a of the through holes 11 serving as the signal lines S1, S2, and S3, and the signal lines S1, S2, and S3 are electrically disconnected from the ground pattern 30A. That is, the ground pattern 30A planarly extends in a horizontal direction while bypassing the signal lines S1, S2, and S3 through the bypass holes 30B.

The substrate 60 for a connector also is held in and fixed to a housing 2 in a state in which the connecting bumps 40 are connected to the connecting pads 51 on the mother board 50, as described above. Further, the flexible printed wiring board 4 having a fitting member 10 which is fitted into the fitting portion 2c of the housing 2, such that the plurality of external connecting portions 4e of the flexible printed wiring board 4 are elastically pressed to come into contact with the plurality of spiral contactors 20 of the substrate 60 for a connector so as to be electrically connected thereto.

Like the first embodiment, in the substrate 60 for a connector, favorable high-frequency characteristics can be obtained, and the number of substantially usable ones as signal lines from the plurality of through holes 11 can be increased.

In addition, when the substrate for a connector is a multi-layered substrate, the ground pattern 30A shown in the second embodiment may be provided on the surface of the substrate for a connector or the ground pattern 12 shown in the first embodiment may be provided on the intermediate layer. Further, the ground pattern 12 shown in the first embodiment may be provided on each of a plurality of intermediate layers. In such a manner, further favorable high-frequency characteristics can be obtained.

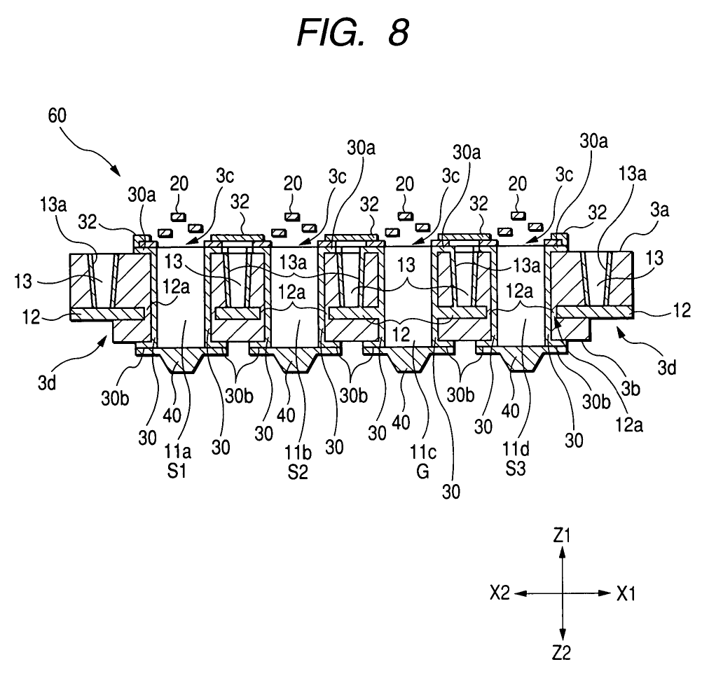

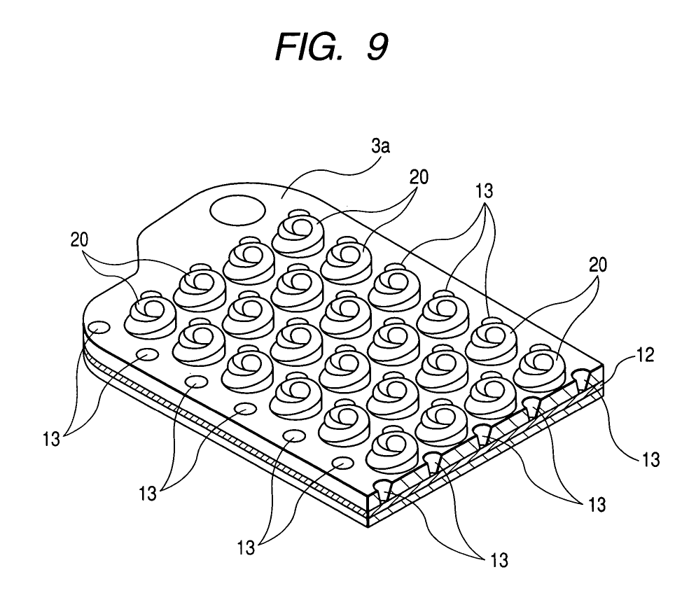

FIG. 8 is a cross-sectional view of a substrate for a connector according to a third embodiment of the invention, which corresponds to FIG. 2. FIG. 9 is a perspective view showing the substrate for a connector in FIG. 8 in a partial cross-sectional view.

The configuration of the substrate 60 for a connector according to the third embodiment of the invention shown in FIGS. 8 and 9 is almost identical to that of the substrate 3 for a connector described in the first embodiment. However, the third embodiment is different from the first embodiment in that a plurality of via holes 13 are formed in the substrate 60 for a connector.

The via holes 13 are formed in a vertical direction (a Z direction) between the ground pattern 12 and the top surface 3a so as to surround one through hole 11 in four directions of the through hole 11, that is, in X1, X2, Y1, and Y2 directions of the through hole 11. On the inner surface of each via hole 13, a conductive layer 13a is formed by plating with a conductive metal, such as Cu or the like. The conductive layer 13a is formed to be continued from the ground pattern 12 and to extend up to the upper edge of the via hole 13 in the top surface 3a. However, in the top surface 3a, the conductive layer 13a of the upper edge of the via hole 13 is electrically disconnected from the upper ends 30a of the through holes 11a, 11b, and 11d serving as the signal line S1, S2, and S3. On the other hand, the conductive layer 13a of the upper edge of the via hole 13 may be electrically connected to the upper end 30a of the through hole 11c serving as the ground line G.

That is, the conductive layer 13a provided on the inner surface of the via hole 13 is electrically connected via the ground pattern 12 to the through hole 11c serving as the ground line G.

For this reason, each of the through holes 11a, 11b, and 11d serving as the signal lines S1, S2, and S3 is surrounded by the conductive layer 13a of the via hole 13 which is electrically connected to the ground line G in four directions. Therefore, stable shield characteristics can be exerted on the signal lines S1, S2, and S3.

That is, each of the through holes 11a, 11b, and 11d serving as the signal lines S1, S2, and S3 is surrounded by the grounded conductive layer 13a in four directions, such that the through holes can be electro-magnetically shielded. Therefore, high-frequency noise which tends to overlap the signal lines S1, S2, and S3, and the like can be removed or lowered. Further, when signals overlapping high-frequency noise pass through any signal lines S1, S2, and S3, the influence of noise on the other signal lines can be reduced. That is, a substrate for a connector having excellent high-frequency characteristics can be provided.

In addition, in the embodiment, the via holes 13 are provided between the ground pattern 12 and the top surface (the first surface) 3a, but the invention is not limited thereto. The via holes may be provided between the ground pattern 12 and the bottom surface (the second surface) 3b. Further, the via holes may be provided both between the ground pattern 12 and the top surface (the first surface) 3a and between the ground pattern 12 and the bottom surface (the second surface) 3b.

According to the invention, the ground pattern can be provided in the vicinities of the plurality of signal lines with the simple configuration and the substrate for a connector having excellent high-frequency characteristics can be provided.

Further, since the connector is a planar connector, a number of contactors can be mounted. Further, even when a number of contactors are mounted in such a manner, the substrate for a connector can be reduced in size.

1. A substrate for a connector comprising:
a first surface on which a plurality of contactors are provided;
a second surface on which a plurality of connecting bumps to be electrically connected to an external circuit substrate are provided; and
a plurality of through holes that are formed to pass through in a vertical direction between the first surface and the second surface and connect the contactors and the connecting bumps, correspondingly,
wherein the through holes form signal lines that transmit signals between the contactors and the connecting bumps and a ground line that serves to ground, and
a ground pattern is provided in the substrate so as to extend from the ground line in a direction perpendicular to the vertical direction while bypassing the signal lines.

2. The substrate for a connector according to claim 1,
wherein the ground pattern is provided on the first surface.

3. The substrate for a connector according to claim 1,
wherein the substrate is a multi-layered substrate, and the ground pattern is provided on an intermediate layer between the first surface and the second surface.

4. The substrate for a connector according to claim 3,
wherein a plurality of via holes, each via hole having a conductive layer, are provided between the ground pattern and at least one of the first surface and the second surface.

5. The substrate for a connector according to claim 1,
wherein a portion of the ground pattern is exposed to the outside of the substrate as a ground terminal.

6. The substrate for a connector according to claim 1,
wherein the contactors and the connecting bumps are arranged in planar matrix shapes.

7. The substrate for a connector according to claim 1,
wherein the contactors are spiral contactors.
